(19) United States
(12) Patent Application Publication
(10) Pub. No.: US 2024/0420179 A1
(43) Pub. Date: Dec. 19, 2024

(54) METHOD

(71) Applicant: TOYOTA JIDOSHA KABUSHIKI KAISHA, Toyota-shi (JP)

(72) Inventors: Makoto AKAHANE, Yokohama-shi (JP); Yu NAGATA, Chofu-shi (JP); Tomokazu MAYA, Nagoya-shi (JP); Masaaki TOMIYA, Urayasu-shi (JP); Yuko MINETA, Chofu-shi (JP); Kayo TSUMOTO, Nisshin-shi (JP); Shinichi NIWA, Nagakute-shi (JP); Satoshi KOMAMINE, Nagoya-shi (JP)

(73) Assignee: TOYOTA JIDOSHA KABUSHIKI KAISHA, Toyota-shi (JP)

(21) Appl. No.: 18/658,207

(22) Filed: May 8, 2024

(30) Foreign Application Priority Data
Jun. 16, 2023 (JP) 2023-099449

(51) Int. Cl. G06Q 30/0251; G06V 10/56

(52) U.S. Cl. CPC G06Q 30/0252; G06Q 30/0255; G06V 10/56

(57) ABSTRACT

The method includes obtaining interest information indicative of an object of interest of a user, selecting advertisement information based on the interest information, and notifying the user of the advertisement information on a way to or from an event venue of the user.

### CROSS-REFERENCE TO RELATED APPLICATION

This application claims priority to Japanese Patent Application No. 2023-099449 filed on Jun. 16, 2023, incorporated herein by reference in its entirety.

### BACKGROUND 1. Technical Field

The present disclosure relates to a method.

### 2. Description of Related Art

Conventionally, a technique of transmitting advertisement data to a mobile object has been known. For example, Japanese Unexamined Patent Application Publication No. 2004-287300 (JP 2004-287300 A) discloses providing advertisement data to a bus as a mobile object.

### SUMMARY

The technique of effectively presenting an advertisement to a user that visits an event site has had room for improvement.

In view of such circumstances, an object of the present disclosure is to improve the technique of presenting an advertisement to a user that visits an event site.

An aspect of the present disclosure provides a method executed by a control device, the method including: acquiring interest information that indicates a target of interest of a user; selecting advertisement information based on the interest information; and notifying the user of the advertisement information on the user's way to or back from an event site.

According to the aspect of the present disclosure, it is possible to improve the technique of presenting an advertisement to a user that visits an event site.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment of the present disclosure; and

FIG. 2 is a flow chart showing the operation of control device.

### DETAILED DESCRIPTION OF EMBODIMENTS

Hereinafter, an embodiment of the present disclosure will be described with reference to the drawings. In each drawing, the same or corresponding portions are denoted by the same reference signs. In the description of the present embodiment, description of the same or corresponding components will be appropriately omitted or simplified.

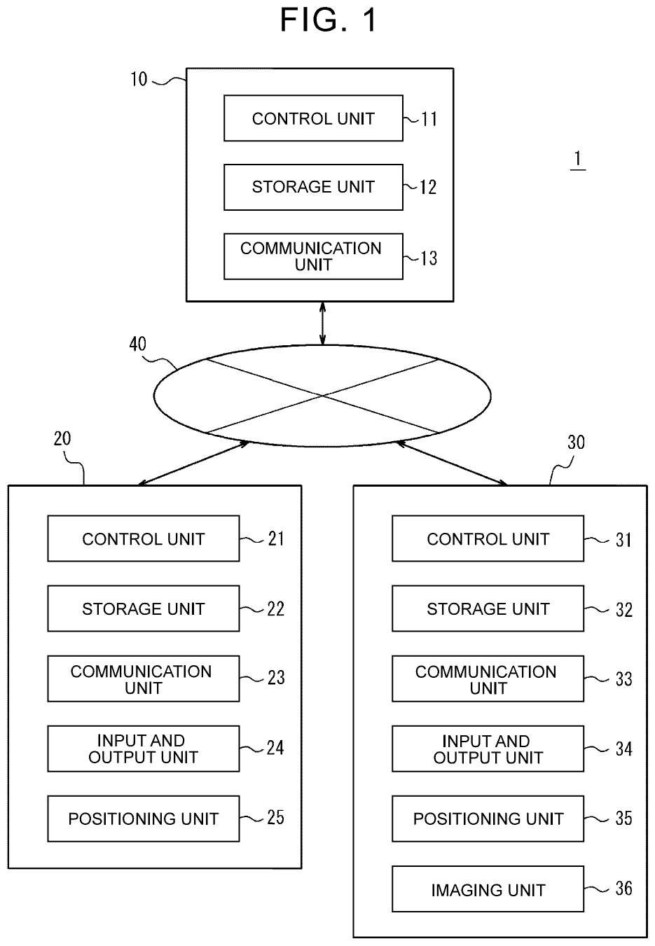

First, an outline of a system 1 according to an embodiment of the present disclosure will be described with reference to FIG. 1. The system 1 includes a control device 10, a terminal device 20, and a vehicle 30. The devices are communicatively connected to each other via a network 40 including, for example, the Internet.

The control device 10 is installed in a facility such as a data center. The control device 10 is, for example, a server belonging to a cloud computing system or another computing system.

The terminal device 20 is held by the user. The terminal device 20 is, for example, a mobile device such as a mobile phone, a smart phone, or a tablet, or a PC. PC is an abbreviation for personal computer.

Vehicle 30 is any type of vehicle that uses power for at least part of its drive, such as Battery Electric Vehicle (BEV), Hybrid Electric Vehicle (HEV), Plug-in Hybrid Electric Vehicle (PHEV), or Fuel Cell Electric Vehicle (FCEV). The vehicle 30 travels with the user on the way to or from the event venue of the user's event. The vehicle 30 may be capable of carrying a plurality of users. The vehicle 30 may be a bus orbiting a plurality of event venues.

The vehicle 30 may be movable by automated driving. The autonomous driving includes, for example, levels 1 to 5 defined in Society of Automotive Engineers (SAE), but is not limited thereto, and may be arbitrarily defined.

Network 40 includes the Internet, at least one WAN, at least one MAN, or a combination thereof. WAN is an abbreviation for wide area network. MAN is an abbreviation for metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

First, the outline of the present embodiment will be described, and the details will be described later. The control device 10 acquires interest information indicating an object of interest of the user, and selects advertisement information based on the interest information. The control device 10 notifies the user of the advertisement information on the way of the user to the event venue or the way of returning from the event venue.

The interest information is information indicating an identifier of the user and an object of interest of the user in association with each other. The user's interests include tourist sports, food and drink, sports, manufacturers or brands, movies, books, music, crafts, vehicles, games, etc. The event hall is a hall for an arbitrary event such as an exhibition, a trade show, or a product exhibition. Within the event venue, a plurality of booths by event organizers, individuals or businesses are exhibited as part of the event. In the event venue, a lecture, a concert, or the like may be held as an event. The advertisement information indicates an advertisement associated with an event held at an event venue, such as a commodity or service displayed at the booth, a guide to each booth at the event venue, a commodity or service sold by an individual or business exhibiting the booth, or an event organizer. According to the present embodiment, the control device 10 can present an advertisement related to an event to the user, which matches the user's interest, in the forward or backward route to the event venue. As a result, the action of the user at the event venue and the action of viewing the advertisement are associated with each other, and the possibility of the user going to the booth indicated by the advertisement after arriving at the event venue or purchasing the product or the like indicated by the advertisement on the return from the event venue is improved. Therefore, it is possible to improve a technique of presenting an advertisement to a user who visits an event venue.

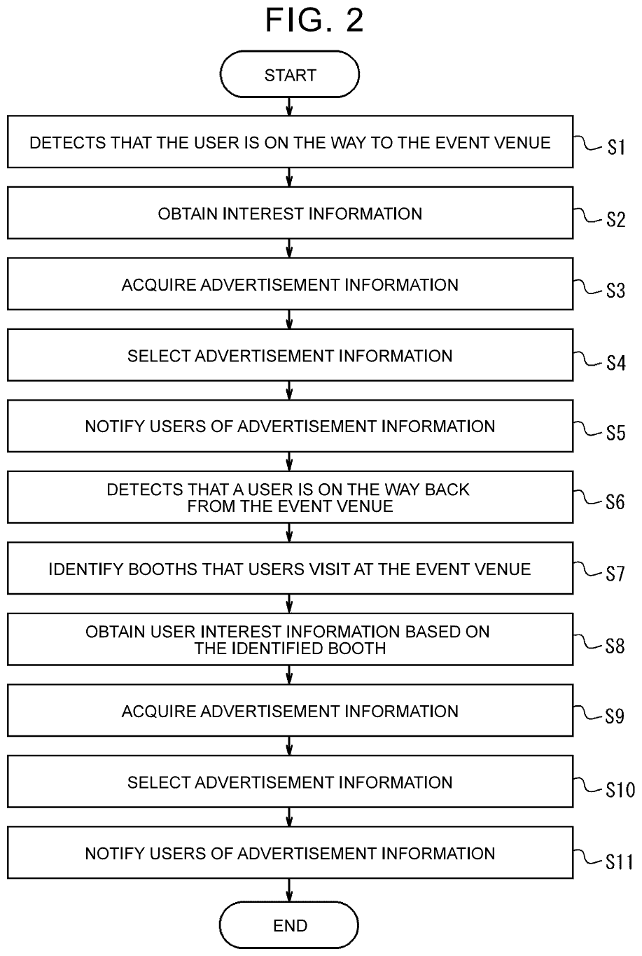

Next, each configuration of the system 1 will be described in detail with reference to FIG. 2.

### Control Device 10

The control device 10 includes a control unit 11, a storage unit 12, and a communication unit 13.

The control unit 11 includes at least one processor, at least one dedicated circuit, or a combination thereof. The processor may be a general-purpose processor, such as a CPU or GPU, or a special-purpose processor specialized for a particular process. “CPU” is an abbreviation for central processing unit. “GPU” is an abbreviation for graphics processing unit. The dedicated circuitry is, for example, a FPGA or an ASIC. “FPGA” is an abbreviation for field-programmable gate array. “ASIC” is an abbreviation for application specific integrated circuit. The control unit 11 executes processing related to the operation of the control device 10 while controlling each unit of the control device 10.

The storage unit 12 includes at least one semiconductor memory, at least one magnetic memory, at least one optical memory, or a combination of at least two of these. The memories are, for example, RAM or ROM. “RAM” is an abbreviation for random access memory. “ROM” is an abbreviation for read only memory. RAM is, for example, SRAM or DRAM. “SRAM” is an abbreviation for static random access memory. “DRAM” is an abbreviation for dynamic random access memory. ROM is, for example, EEPROM. “EEPROM” is an abbreviation for electrically erasable programmable read only memory. The storage unit 12 functions as, for example, a main storage device, an auxiliary storage device, or a cache memory. The storage unit 12 stores information used for the operation of the control device 10 and information obtained by the operation of the control device 10. For example, the storage unit 12 may store a system program, an application program, a database, map information, and the like. The information stored in the storage unit 12 may be updatable by information acquired from the network 40 via the communication unit 13. The communication unit 13 includes at least one communication interface.

The communication interface is, for example, a LAN interface, a LAN interface, or an interface corresponding to a mobile communication standard such as an LTE, 4G or a 5G. The term “LTE” is an abbreviation for “long term evolution”. The term “4G” is an abbreviation for “fourth generation”. The term “5G” is an abbreviation for “fifth generation”. The communication unit 13 receives data used for the operation of the control device 10 and transmits data obtained by the operation of the control device 10.

The function of the control device 10 is realized by executing the program according to the present embodiment by a processor corresponding to the control unit 11. That is, the function of the control device 10 is realized by software. The program causes the computer to execute the operation of the control device 10, thereby causing the computer to function as the control device 10. That is, the computer functions as the control device 10 by executing the operation of the control device 10 in accordance with the control program.

The program can be stored in a non-transitory computer-readable medium. The non-transitory computer-readable medium in this embodiment is a ROM. Non-limiting examples of the non-transitory computer-readable medium include a magnetic recording device, an optical disk, and a magneto-optical recording medium. The distribution of the program is carried out, for example, by selling, transferring, or renting a portable medium such as a DVD or a CD-ROM in which the program is stored. The term “DVD” is an abbreviation for “digital versatile disc”. The term “CD-ROM” is an abbreviation for “compact disc read only memory.” The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program.”

Some or all of the functions of the control device 10 may be realized by a programmable circuit or a dedicated circuit as the control unit 11. That is, a part or all of the functions of the control device 10 may be implemented by hardware.

### Terminal Device 20

The terminal device 20 includes a control unit 21, a storage unit 22, a communication unit 23, an input/output unit 24, and a positioning unit 25.

The hardware configurations of the control unit 21, the storage unit 22, and the communication unit 23 of the terminal device 20 may be the same as the hardware configurations of the control unit 11, the storage unit 12, and the communication unit 13 of the control device 10, respectively. The description here is omitted.

The input/output unit 24 includes at least one input/output interface. The input/output interface includes a touch screen integrally provided with the display. The input/output unit 24 receives an operation of inputting information used for the operation of the terminal device 20, and outputs information obtained by the operation of the terminal device 20. Instead of being provided in the terminal device 20, the input/output unit 24 may be connected to the terminal device 20 as an external input device. As a connection method, for example, any method such as a universal serial bus (USB), a high-definition multimedia interface (HDMI) (registered trademark), or Bluetooth (registered trademark) can be used. The input/output unit 24 may not be integrated, but may be constituted by a separate input unit and an output unit. In this case, the input unit includes at least one input interface such as a physical key, a capacitive key, a pointing device, or a microphone. The output includes at least one output interface, such as a display or speaker.

The positioning unit 25 includes at least one GNSS receiver. GNSS is an abbreviation for global navigation satellite system. GNSS is, for example, GPS, QZSS, BeiDou, GLONASS, or Galileo. GPS is an abbreviation for Global Positioning System. “QZSS” is an abbreviation for Quasi-Zenith Satellite System. The satellites of the QZSS are referred to as quasi-zenith satellites. GLONASS is an abbreviation for Global Navigation Satellite System. The positioning unit 25 measures the position of the terminal device 20.

### Vehicle 30

The vehicle 30 includes a control unit 31, a storage unit 32, a communication unit 33, an input/output unit 34, a positioning unit 35, and an imaging unit 36. Each component of the vehicle 30 is communicably connected to each other via, for example, a dedicated line.

The hardware configurations of the control unit 31, the storage unit 32, and the communication unit 33 of the vehicle 30 may be the same as the hardware configurations of the control unit 11, the storage unit 12, and the communication unit 13 of the control device 10, respectively. The hardware configurations of the input/output unit 34 and the positioning unit 35 of the vehicle 30 may be the same as the hardware configurations of the input/output unit 24 and the positioning unit 25 of the terminal device 20.

The imaging unit 36 includes a camera such as an outside camera or an inside camera. The imaging unit 36 can capture an image of a user riding on the vehicle 30. The imaging unit 36 records the captured image in the storage unit 32 or outputs the captured image to the control unit 31. The image includes a still image or a moving image.

The operation of the control device 10 according to the present embodiment will be described with reference to FIG. 2. This operation corresponds to the method according to the present embodiment. Hereinafter, the control device 10 transmits and receives information to and from each device via the communication unit 13 and the network 40. From S1 to S5 in FIG. 2, the operation of the control unit 11 of the control device 10 in the forward direction to the event hall of the user is illustrated. S11 from S6 indicates the operation of the control unit 11 on the return route from the event hall of the user.

In S1 of FIG. 2, the control unit 11 of the control device 10 detects that the user is in the forward direction toward the event hall. Any method may be employed for detecting that the user is in the forward direction. For example, the control unit 11 communicates with the terminal device 20 and receives, from the terminal device 20, information indicating that the user has set the destination of an arbitrary route search application as the event venue and position information indicating the position of the user. The control unit 11 may detect that the user is in the forward direction when determining that the user has started moving based on the information and the position information. The control unit 11 may acquire, from the vehicle 30, position information indicating the position of the vehicle 30 measured by the positioning unit 35, and detect that the user is on the forward path based on the position information. In the present example, the control unit 11 detects that the user has ridden on the vehicle 30 that is going to the event hall of the Hokkaido exhibition, thereby detecting that the user is going to the event hall. Any method may be employed for detecting that the user has ridden on the vehicle 30. For example, the control unit 11 acquires, from the terminal device 20, position information indicating the position of the user measured by the positioning unit 25, and detects that the user has ridden on the vehicle 30 based on the position information. The control unit 11 may acquire an image obtained by capturing the inside of the vehicle from the vehicle 30, analyze the image by an arbitrary image processing technique to identify the user, and detect that the user has ridden on the vehicle 30.

In S2, the control unit 11 acquires interest information indicating an object of interest of the user. Any method may be employed for acquiring the interest information. The control unit 11 may acquire the interest information by reading the interest information from the storage unit 12. The present disclosure is not limited thereto, and the control unit 11 may transmit information indicating an inquiry of an object of interest to the terminal device 20, receive an answer input by the user to the terminal device 20, and acquire the received answer as interest information in association with an identifier of the user. In this case, the identifier of the user may be an identifier of the terminal device 20. In this example, the control unit 11 acquires interest information indicating a tourist spot “Sapporo” as an interest target of the user.

The present disclosure is not limited to this, and the control unit 11 may acquire the interest information by generating the interest information based on the purchase history of the product or service of the user. In this case, the control unit 11 acquires information indicating the purchase history from a server such as a credit card provider used by the user. The control unit 11 may generate the interest information according to the commodity or the service indicated by the purchase history. Any language analysis technique may be adopted for determining the object of interest. For example, in a case where the information indicating the purchase history indicates a travel guidebook in Sapporo, the control unit 11 may acquire the information by generating the interest information in which the object of interest of the user is “Sapporo”.

In S3, the control unit 11 acquires the advertisement information associated with the event in the event hall. Any method may be employed for acquiring the information. For example, the advertisement information is preset by a business operator exhibiting at an event venue, an organizer of an event, or the like, and stored in the storage unit 12. The control unit 11 acquires the advertisement information by reading the advertisement information with reference to the storage unit 12. The present disclosure is not limited to this, and the control unit 11 may acquire the advertisement information from an advertisement distribution server such as a business operator who opens or plans a booth or a show, or an event organizer. The control unit 11 may acquire a plurality of pieces of advertisement information. In the present example, the control unit 11 acquires advertisement information indicating the Sapporo tour guided in the booth and the venue map up to the booth with respect to the booth related to “Sapporo” which is opened as an event at the event venue of the Hokkaido exhibition. The control unit 11 also acquires, for the booth related to “Hakodate”, advertisement information indicating the Hakodate tour guided in the booth and the venue map up to the booth.

In S4, the control unit 11 selects advertisement information based on the interest information. The control unit 11 may select the advertisement information related to the object of interest of the user from among the plurality of advertisement information acquired by S3. Any method may be employed for the selection. The control unit 11 may select the advertisement information related to the object of interest of the user by using any natural language processing technique. For example, when the object of interest of the user indicated by the interest information is a sweet, the control unit 11 selects advertisement information about a booth of a Japanese confectionery shop, a booth of a Western confectionery shop, a booth of a confectionery company, or the like as advertisement information related to the object of interest of the user. In the present embodiment, the control unit 11 selects, from among the advertisement information acquired by S3, advertisement information indicating the Sapporo tour and the venue map up to the booth, which are guided in the booth related to “Sapporo” which is the object of interest of the user.

In S5, the control unit 11 notifies the user of the advertisement information. Any method may be employed for the notification. For example, the control unit 11 transmits advertisement information to the terminal device 20 of the user, and the control unit 21 of the terminal device 20 displays the advertisement information to the user via the input/output unit 24. In this example, the control unit 11 transmits advertisement information indicating a tourist tour in Sapporo and a venue map up to a booth related to “Sapporo” to the terminal device 20, and the advertisement information is displayed on the input/output unit 24 of the terminal device 20.

In S6, the control unit 11 detects that the user is on the return from the event hall. Any method may be employed for detecting that the user is on the return path. For example, the control unit 11 communicates with the terminal device 20, and receives, from the terminal device 20, information indicating that the user has set the destination of an arbitrary route search application to his/her home and started moving, and position information indicating the position of the user. The control unit 11 may detect that the user is on the return path when determining that the user has started moving based on the information and the position information. In the present example, the control unit 11 detects that the user has ridden on the vehicle 30 leaving the event hall, thereby detecting that the user is on a return route from the event hall. Any method may be employed for detecting that the user has ridden on the vehicle 30. For example, similarly to SI, the control unit 11 acquires position information indicating the position of the user from the terminal device 20, and detects that the user has ridden on the vehicle 30 based on the position information. The control unit 11 may acquire an image obtained by capturing the inside of the vehicle from the vehicle 30, analyze the image by an arbitrary image processing technique to identify the user, and detect that the user has ridden on the vehicle 30.

In S7, the control unit 11 identifies the booth that the user visited at the event venue. Any particular technique may be employed. For example, the control unit 11 acquires an image in which a user's baggage is captured, and identifies a booth visited by the user based on the baggage identified from the image. In the present example, the control unit 11 acquires, from the vehicle 30, an image obtained by the imaging unit 36 capturing the user, and identifies, from the image, a package possessed by the user using an arbitrary image analysis technique. The control unit 11 identifies the booth that the user has visited at the event venue based on the identified result. For example, when the control unit 11 specifies that the luggage held by the user is a goods or a flyer distributed in a booth, the booth is specified as a booth visited by the user.

In the present embodiment, the luggage specified by the control unit 11 is a shopping bag that is passed to the user when the merchandise is sold in each booth or when the novelty goods are passed, and the color differs for each booth. The control unit 11 determines the color of the shopping bag, and specifies the color of the shopping bag having the largest number held by the user. The control unit 11 identifies the booth visited by the user by referring to information indicating the color of the shopping bag and the booth in association with each other. The information is set in advance by an event organizer or the like and stored in the storage unit 12. The control unit 11 may acquire the information from the server of the organizer of the event venue. In this example, the user holds three red bags, one blue bag, and one yellow bag. In the Hokkaido exhibition of the present example, it is assumed that the red color is the color of the booth related to Hakodate, the blue color is the color of the booth related to Kushiro, and the yellow color is the color of the bag used in the booth related to Sapporo. In this case, the control unit 11 identifies a booth related to “Hakodate” in which a red bag having the largest number of users is used, as a booth visited by the user at the event venue.

The present disclosure is not limited thereto, and the control unit 11 may identify the booth visited by the user by acquiring the position information of the user from the terminal device 20 of the user. The control unit 11 may acquire a video captured by a camera provided in the event hall, and analyze the video using an arbitrary image analysis technique to identify a booth visited by the user. In this case, the control unit 11 may identify the booth having the longest user's stay time as the booth visited by the user.

In S8, the control unit 11 acquires the interest information of the user based on the identified booth. Specifically, the control unit 11 acquires the interest information by reading the information stored in the storage unit 12 in which the booth and the interest information are associated in advance. The information is set in advance and stored in the storage unit 12. In this example, interest information indicating “Hakodate” is associated with the booth visited by the user in advance. In this case, the control unit 11 acquires interest information indicating “Hakodate” as an interest target of the user.

The present disclosure is not limited to this, and any method may be adopted for acquiring the interest information based on the booth visited by the user. For example, the control unit 11 acquires information in which the booth and the category to which the booth belongs are associated in advance and information in which the category and the interest information are associated in advance stored in the storage unit 12. For example, it is assumed that, in the information, a booth visited by the user and a category indicating “kitchen utensil” are associated in advance, and further, a category of “kitchen utensil” and interest information of “cooking” are associated in advance. In this case, the control unit 11 acquires interest information indicating “cooking” as an interest target of the user.

In S9, the control unit 11 acquires the advertisement information associated with the event in the event hall. Any method may be employed for acquiring the information. For example, the advertisement information is preset by a business operator exhibiting at an event venue, an organizer of an event, or the like, and stored in the storage unit 12. The control unit 11 acquires the advertisement information by reading the advertisement information with reference to the storage unit 12. The present disclosure is not limited to this, and the control unit 11 may acquire the advertisement information from an advertisement distribution server such as a business operator who opens or plans a booth or a show, or an event organizer. The control unit 11 may acquire a plurality of pieces of advertisement information.

In S10, the control unit 11 selects advertisement information based on the interest information. Specifically, the control unit 11 selects advertisement information indicating an advertisement related to an object of interest indicated by the interest information acquired by S8. Any method may be employed for selecting the advertisement information. In the present example, the control unit 11 selects the advertisement information indicating the sightseeing tour of Hakodate as the advertisement information related to the object of interest “Hakodate” indicated by the interest information.

The control unit 11 may select the advertisement information based on the interest information acquired by S2 in addition to the interest information acquired by S8. For example, when the object of interest acquired by S2 is “sweet” and the object of interest acquired by S8 is “Hakodate”, the control unit 11 may select the advertisement information related to the product of the sweet shop in Hakodate. Similarly, for example, when the object of interest acquired by S2 is “seafood” and the object of interest acquired by S8 is “Hakodate”, the control unit 11 may select the advertisement information related to the seafood restaurant in Hakodate or the advertisement information related to the tourist tour to the market in Hakodate.

In S11, the control unit 11 notifies the user of the advertisement information. For example, the control unit 11 transmits advertisement information to the terminal device 20 of the user, and the control unit 21 of the terminal device 20 displays the advertisement information to the user via the input/output unit 24. In this example, the control unit 11 transmits advertisement information indicating a sightseeing tour of Hakodate to the terminal device 20 of the user, and the advertisement information is displayed on the input/output unit 24 of the terminal device 20. Thereafter, the processing of the control unit 11 ends.

As described above, the control unit 11 of the control device 10 according to the present embodiment acquires the interest information indicating the object of interest of the user, selects the advertisement information on the basis of the interest information, and notifies the user of the advertisement information on the way of the user to the event hall or on the way back from the event hall. According to the present embodiment, an advertisement that matches the user's interest is presented to the user. Therefore, it is possible to improve the possibility that a user who has viewed an advertisement in the forward or backward direction to the event venue takes an action such as going to a booth indicated by the advertisement after arriving at the event venue, or purchasing a product or the like indicated by the advertisement after returning home from the event venue. Therefore, it is possible to improve a technique of presenting an advertisement to a user who visits an event venue.

As described above, in the control device 10 according to the present embodiment, the control unit 11 selects the advertisement information related to the object of interest of the user from the plurality of advertisement information associated with the event in the event hall. According to the present embodiment, since the advertisement information related to the event venue and suitable for the target of interest of the user is selected, the effect of the advertisement on the user visiting the event venue can be increased. Therefore, it is possible to improve a technique of presenting an advertisement to a user who visits an event venue.

As described above, in the control device 10 according to the present embodiment, the control unit 11 identifies the booth visited by the user in the event hall, and acquires the interest information based on the booth. According to the present embodiment, it is possible to provide the user with the advertisement information reflecting the experience at the event venue shortly after the user visits the event venue, and thus it is possible to increase the effect of the advertisement on the user. Therefore, it is possible to improve a technique of presenting an advertisement to a user who visits an event venue.

As described above, in the control device 10 according to the present embodiment, the control unit 11 acquires an image in which the user's baggage is captured, and identifies the booth based on the baggage held by the user identified from the image. According to the present embodiment, the control unit 11 can accurately identify the booth that the user has visited with interest at the event venue from the baggage held by the user, and can acquire the interest information based on the booth and output the advertisement information. Therefore, it is possible to improve a technique of presenting an advertisement to a user who visits an event venue.

As described above, in the present embodiment, the baggage includes a shopping bag. The control unit 11 specifies the booth based on the color of the shopping bag. According to the present embodiment, even when there is a plurality of bags that the user has, it is possible to identify the booth that the user has the most interest by discriminating by color. Therefore, it is possible to improve a technique of presenting an advertisement to a user who visits an event venue.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, in S5 and S11, the control unit 11 may transmit the advertisement information to the vehicle 30 on which the user is riding. In this case, the control unit 31 of the vehicle 30 receives the advertisement information and causes the input/output unit 34 to display the advertisement information. As a result, advertisement information is notified to the user riding on the vehicle 30.

For example, in S7, the control unit 11 may identify a booth visited by the user based on images captured by the user using the terminal device 20. Specifically, the control unit 11 acquires an image captured by the terminal device 20 by the user by receiving the image from the terminal device 20, and specifies a package possessed by the user by using an image analysis technique of an arbitrary image. The control unit 11 identifies the booth that the user has visited at the event venue based on the identified result. For example, in a case where a goods, a flyer, or the like distributed in a certain booth is specified as a package from an image received from the terminal device 20, the control unit 11 specifies the booth as a booth visited by the user.

For example, in S7, the control unit 11 may specify a booth that a plurality of users riding on the vehicle 30 visited at the event hall. Specifically, the control unit 11 acquires an image captured by the imaging unit 36 of the vehicle 30, specifies the color of the shopping bag most possessed by the plurality of users from the image using an arbitrary image analysis technique, and specifies a booth using the shopping bag of the color. In S8, the control unit 11 acquires interest information of each of a plurality of users based on the identified booth, and acquires and selects advertisement information related to an object of interest indicated by the interest information in S9 and S10. At this time, the control unit 11 may select a plurality of pieces of advertisement information. The control unit 11 transmits the plurality of pieces of advertisement information to the vehicle 30 in S11. The control unit 31 of the vehicle 30 receives the plurality of pieces of advertisement information, and displays the plurality of pieces of advertisement information via the input/output unit 34 such as an in-vehicle display. This makes it possible to effectively present advertisements that are likely to be of interest to each of a plurality of users riding on the vehicle 30 on a return road from the event hall.

What is claimed is:

1. A method executed by a control device, the method comprising:
acquiring interest information that indicates a target of interest of a user;
selecting advertisement information based on the interest information; and
notifying the user of the advertisement information on the user's way to or back from an event site.

2. The method according to claim 1, further comprising selecting advertisement information associated with the target of interest of the user from among a plurality of pieces of advertisement information associated with an event at the event site.

3. The method according to claim 1, further comprising specifying a booth visited by the user at the event site and acquiring the interest information based on the booth.

4. The method according to claim 3, further comprising:
acquiring an image in which baggage of the user is captured; and
specifying the booth based on the baggage specified from the image.

5. The method according to claim 4, wherein the baggage includes a shopping bag, and the method further includes specifying the booth based on a color of the shopping bag.
